(19) United States
(12) Patent Application Publication
(10) Pub. No.: US 2020/0081413 A1
(43) Pub. Date: Mar. 12, 2020

(54) SYSTEM AND METHOD FOR GENERATING AN ORTHODONTIC APPLIANCE

(71) Applicants: Ralph Georg, Miami, FL (US); Christian Coachman, Miami, FL (US)

(72) Inventors: Ralph Georg, Miami, FL (US); Christian Coachman, Miami, FL (US)

(73) Assignee: DSD Applicant LLC, Miami, FL (US)

(21) Appl. No.: 16/124,619

(22) Filed: Sep. 7, 2018

(51) Int. Cl. G05B 19/4099; G06F 17/50; A61C 7/00; A61C 9/00

(52) U.S. Cl. CPC G05B 19/4099; G06F 17/5009; G06T 3/60; A61C 9/0046; G05B 2219/49023; A61C 7/002

(57) ABSTRACT

The present embodiments, discloses a system and method for generating an aesthetic appliance including a clinical site having a plurality of imaging devices to capture digital imagery of a patient. A computing device receives the digital imagery and transmits the imagery, via a network, to an aesthetic appliance production site. The aesthetic appliance production site includes an aesthetic appliance production device configured to produce the aesthetic appliance.

### TECHNICAL FIELD

The embodiments presented provide a system and method for generating an aesthetic appliance using a computer program.

### BACKGROUND

One of the most critical steps to increase case acceptance for aesthetic treatment of a smile is to present the patient with a rendering of their new smile. Today's orthodontists often take plaster models of the upper and lower jaw and cut the model into single tooth models which are aligned and positioned within the wax bed. A wire can then be bound to a bracket positioned on each tooth. This informs the orthodontist of the necessary geometry of the wire to achieve the desired aesthetic result. Small templates for every tooth would then be made to ensure the brackets will be bonded at a proper location on the teeth of the patient. Such an approach requires a significant amount of time, labor, and accuracy resulting in high costs to the patient.

More recently, computer-driven approaches have been utilized to visualize the untreated jaw and plan a treatment. These system do not provide the opportunity to pre-model the new smile of the patient using a variety of 3-dimensional views which can be used to help convert the potential client to buy the final developed aesthetic appliance.

Advances in the arts related to the presentation of a digital rendering of a patient's smile as well as the generation of an orthodontic appliance therefrom are needed in the current arts. One such advance is described in the various embodiments presented herein.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

The embodiments described herein provide for a system and method for generating a dentition simulation and producing an aesthetic appliance therefrom. The system includes a clinical site having a plurality of imaging devices to capture digital imagery corresponding to the craniofacial dimensions of a patient. A computing device receives the digital imagery and transmits the digital imagery, via a network, to an aesthetic appliance production site. The production site includes and appliance generation device to produce a digital rendering appliance, in addition to an aesthetic appliance production device to create a model from the rendering.

In an embodiment, a method is provided for constructing a customized aesthetic appliance. The method begins by capturing, via the plurality of imaging devices, a plurality of digital imagery of the patient. Digital imagery is then transmitted to the computing device via a processor coupled thereto. The user then calibrates the digital imagery and selects a template having a plurality of tooth configurations to select from. Once a template and the desired configurations have been selected, a dentition simulation is provided to the patient which illustrates a final dentition and rendering of a smile is constructed. A file is then generated having the dentition simulation therein. The file is sent to the aesthetic appliance production site wherein the aesthetic appliance is manufactured.

In one aspect, the computing device is a personal electronic device. Preferentially, a mobile computing device such as a tablet is utilized to provide appropriate image size and calibration functionality.

In one aspect, the digital imagery includes at least the following: a frontal facial image, a 12 O'clock image, and an occlusal view image. The occlusal view image can be an intraoral scan of the patient.

In another aspect, the step of calibrating the digital imagery further comprises the step of calibrating the intraoral scan to the frontal facial image and the 12 O'clock image.

In yet another aspect, the aesthetic appliance production device is a 3D printer or milling machine. The 3D printer or milling machine can be provided at the clinical site, such that the 3D printer or milling machine is in operable communication with the computing device to receive the dentition simulation therefrom.

Moreover, in accordance with a preferred embodiment of the present invention, other aspects, advantages, and novel features of the present invention will become apparent from the following detailed description in conjunction with the drawings.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1 illustrates a block diagram of a system for generating an aesthetic appliance, according to some embodiments;

FIG. 2 illustrates a block diagram for capturing digital imagery at the clinical site, according to some embodiments;

FIG. 3 illustrates the user interface and frontal facial imagery of the patient, according to some embodiments;

FIG. 4 illustrates the user interface and frontal facial imagery of the patient, according to some embodiments;

FIG. 5 illustrates the user interface and 12 O'clock view imagery of the patient, according to some embodiments;

FIG. 6 illustrates an occlusal view generated from an intraoral scan of the patient, according to some embodiments;

FIG. 7 illustrates the design interface presented on the computing device, according to some embodiments;

FIG. 8 illustrates the design interface presented on the computing device, according to some embodiments;

FIG. 9 illustrates the design interface presented on the computing device, according to some embodiments;

FIG. 10 illustrates a four-view user interface of the dentition image, according to some embodiments;

FIG. 11 illustrates a four-view user interface of the dentition image, according to some embodiments;

FIG. 12 illustrates a final rendering having before and after images of the patient, according to some embodiments;

FIG. 13 illustrates a flowchart of a method for generating an aesthetic appliance, according to some embodiments; and

FIG. 14, illustrates a flowchart of a method for calibrating 3D facial image, according to some embodiments.

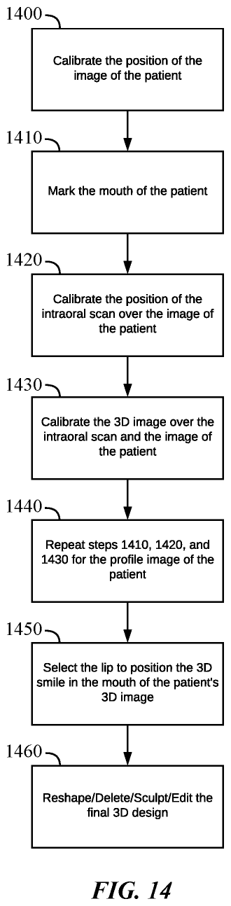

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages or may include different advantages. Any advantages described herein are not to be construed as limiting to any of the claims.

Before describing in detail exemplary embodiments, it is noted that the embodiments reside primarily in combinations of components related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second” and the like, may be used solely to distinguish one entity or element from another entity or element without necessarily requiring or implying any physical or logical relationship or order between such entities or elements.

In general, the embodiments disclosed herein relate to capturing images from various sources that provide volumetric and surface images that are 3-dimensional (3D) or 2-dimensional (2D). These images can be static or dynamic, such as from CBCT, CAT, MRI, fMRI, ultrasound devices, cameras, white light and laser-based surface scanners, video cameras, and other implements known in the arts. Images from these sources are combined to form a unified simulation model of the craniofacial and dental facial complex. It is an aspect of the present embodiments to facilitate diagnosis, treatment planning, and accurate design of aesthetic appliances. Further, in an attempt to increase case acceptance for the aesthetic treatment, it is a goal of the present embodiments to produce a physical model of the new dentition (i.e., smile) allowing the patient to see and feel the projected treatment.

In the following description, the term “user” can be used to describe and indicate a patient, an orthodontist, a dentist, other forms of medical professionals, administrators, or production associates involved with the generation, fabrication, and production of the aesthetic appliance.

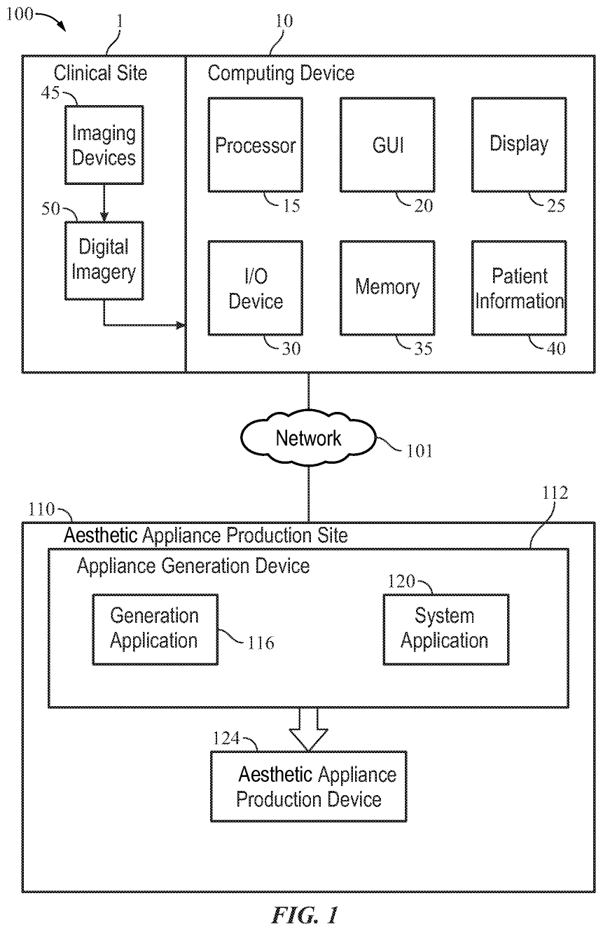

In reference to FIG. 1, a block diagram of the system 100 for generating an aesthetic appliance is illustrated. The system 100 at least includes a clinical site 1 having a computing device 10 comprised of a processor 15, a graphical user interface (GUI) 20, a display 25, at least one input/output (I/O) device 30, a memory 35, and required patient information 40.

The computing device 10 includes any suitable computational device, such as a personal computer, a workstation, a server, a mainframe, a handheld computer, mobile computing device, a palmtop computer, a network appliance, a server, or any device capable of receiving or transmitting information. A network 101 communicatively couples the computing device 10 and the appliance generation device 112 may comprise any suitable network, such as the Internet, a wide area network, a peer-to-peer network, a client-server network, and other means known in the arts.

The memory 35 may be local memory or may be a fixed or removable storage medium such as a flash card. The system provides the GUI 20 configured to display digital imagery on the display 25. One or more portions of the system 100 may be distributed across one or more computer systems coupled to a communications network. For example, various aspects of some embodiments may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments. These components may be executable, intermediate (e.g., IL) or interpreted (e.g., Java) code which communicates over a communication network (e.g., the Internet) using a communication protocol (e.g., TCP/IP).

The I/O device(s) 30 can include keyboards, touch-based applications, a mouse, tactile feedback mechanisms, cameras, and other I/O device known in the arts.

The system 100 may include a server process that responds to requests from one or more client programs. The process may include, for example, an HTTP server or other server-based processes (e.g., a database server process, XML server, peer-to-peer process) that interfaces to one or more client programs distributed among one or more client systems.

A unified workstation environment and computer system for diagnosis, treatment planning and delivery of therapeutics, specially adapted for treatment of craniofacial structures, is described below. In one example, the system is particularly useful in diagnosis and planning treatment of an patient. Persons skilled in the art will understand that the embodiments, in their broader aspects, applies to other craniofacial disorders or conditions requiring surgery, prosthodontic treatment, restorative treatment, etc.

In an embodiment, an appliance generation device 112 may be located in an aesthetic appliance production site 110. The aesthetic appliance production site 110 may be a facility, building, campus, plant, etc., directly or indirectly controlled by the manufacturer or designer of an orthodontic or similar aesthetic device, such as an orthodontic brace. The appliance generation device 112 is comprised of at least a generation application 116 and a system application 120 configured to transmit information to an aesthetic appliance production device 124.

The aesthetic production device 124 can include a 3D printer or milling machine located at the clinical site 1 permitting the practitioner to rapidly produce a model of the appliance. This can include a network connection or wired connection between the 3D printer or milling machine and the clinical site 1 computing device 10.

The clinic site 1 may be a dentist's office, an orthodontist's office, a dental hospital, a clinic, an imaging center, etc. A dental practitioner, such as an orthodontist, dentist, dental assistant, or other people interested in creating an aesthetic appliance, may use the computing device 10 to generate a prescription for an aesthetic appliance. In certain embodiments, the aesthetic appliance production site 110 and the clinic site 1 may be separated geographically from one another while the network 101 may provide the communications infrastructure coupling the aesthetic appliance production site 110 and the clinic site 1.

The clinic site 1 may include a plurality of imaging devices 45, such as still cameras, video cameras, intra-oral (I/O) scanners, cone beam scanners, X-ray machines, magnetic resonance imagery (MRI) machines, ultrasound machines and other imaging devices (e.g., electron beam imaging devices). The dental practitioner may use the imaging devices 45 to generate digital imagery 50 of the patient's 200 teeth, jaws, soft tissue, and other features to quickly and accurately produce a model of the appliance.

The computing device 10 can include patient information 40 including prior clinical data, contact information, imagery, and other useful information commonly associated and used in orthodontics and dentistry. The patient information 40 can also include patient preferences for the treatment plan and appliance.

To provide an aesthetic appliance to the patient 200, information is exchanged between the computing device 10 and the aesthetic appliance generation device 112. Once the aesthetic appliance is manufactured by the aesthetic appliance production device 124, the aesthetic appliance is sent to the clinic site 1.

The quantification of the smile that is desired on a patient may lead to the appliance generation device 112 in combination with a rule-based system application to design a suitable appliance to achieve a desired aesthetic smile for the patient 200.

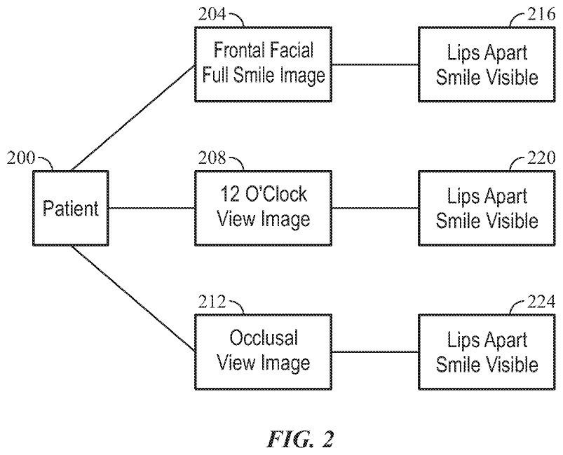

FIG. 2 illustrates a block diagram related to the capture of digital imagery 50 at the clinical site 1. In each view of the digital imagery 50, the patient 200 provides a visible smile with their lips apart (reference numerals 216, 220, and 224). In the preferred embodiment, a frontal facial image 204, 12 O'clock image 208, and occlusal view image 212 are captured. One skilled in the arts will understand that additional views and perspectives of the patient 200 can be captured and utilized including profile images captured from the left and/or right side of the face, three-quarter views of the face, or other useful perspectives.

Digital imagery 50 can include 3D craniofacial scans and photographs which are captured of the patient 200. The 3D digital imagery can be displayed and interacted with on the GUI 20 showing 360° views of the face of the patient 200 in addition to the intraoral scan and smile simulation. The 360° view is provided with the dentition simulation to the patient so they can visualize their own craniofacial complex.

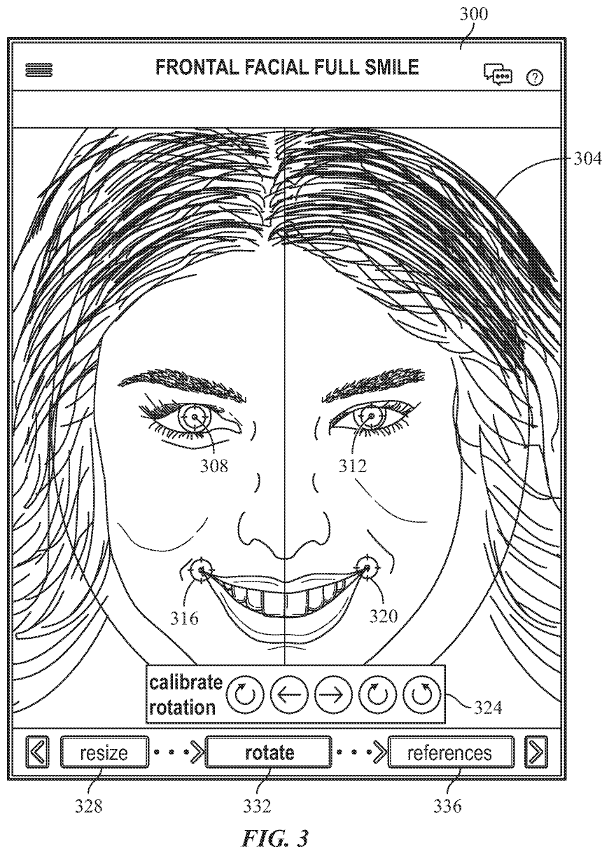

FIGS. 3-12 illustrate exemplary screenshots of the graphical user interface 20 showing digital imagery 50 captured from the imaging devices 45. In specific reference to FIG. 3, a calibration interface 300 displays facial imagery 304 of the patient 200. The system 100 determines locations of the commissural line, which continues between the right pupil 308 and the left pupil 312, and intra-pupilar line, which extends between the right corner of the mouth 316 and the left corner of the mouth 320, are never parallel to one another. Rotation is required which is based on the average value of the commissural and intra-pupilar lines. A rotation interface 324 is provided having a plurality of controls to permit the rotation of the face image 304. The user can resize 328 the facial image, rotate 332 the facial image, and consult with references 336 stored in the memory 35. In use, the user will mark the mouth to display the intraoral scan 400 in the mouth by erasing the smile from the face and inputting the intraoral scan 400 within the calibrated and marked image.

Once calibrated, the user identifies the lip(s) of the patient on the frontal view, profile view, and 12 O'clock view, an intraoral scan 400 provided by one of the imaging devices 45 is superimposed over the facial image 304. Calibration is required which includes resizing, rotating, shifting, or otherwise amending the superimposed intraoral scan 400 to fit the facial image 304 appropriately. Intraoral scan calibration controls 404 are provided on the GUI 20.

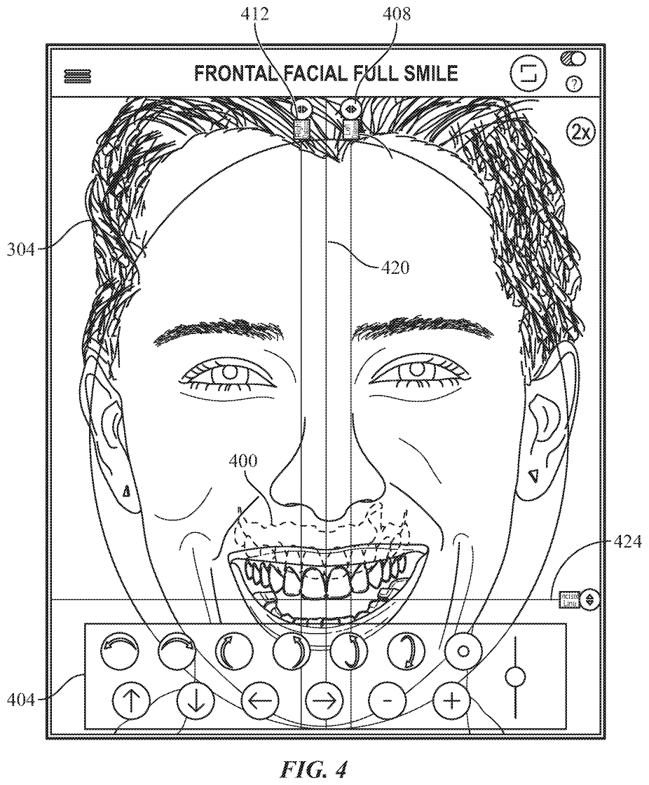

Referring to FIG. 4, the user calibrates the position of the intraoral scan 400 over the image of the patient 200. The process of calibration utilizes the incisal line 424, medial line 420, and adjustable right and left distance lines 408, 412.

In one embodiment, the user calibrates the position of the intraoral scan 400 over the picture of the patient 200. The 3D facial image is then calibrated over the picture of the patient 200 and the intraoral scan 400. Further, a profile image (shot shown) of the patient 200 can be utilized to calibrate the intraoral scan 400. The 3D facial image is then once more calibrated over the profile image of the patient 200 and the intraoral scan 400. During the process of calibrating the image, the user can mark the mouth using calibration controls 404 and controls 316, 320.

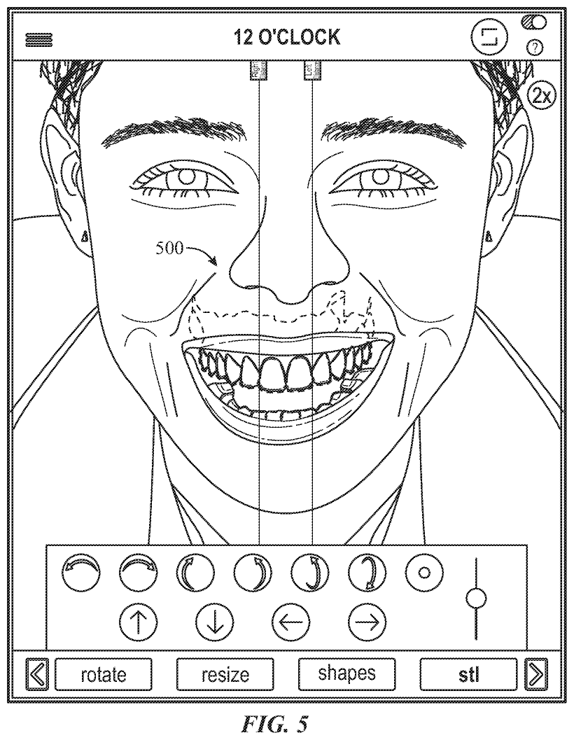

Now referring to FIG. 5, the 12 O'clock view 500 is shown and provided with similar calibration controls. The user performs the same procedure for calibrating both the facial view and the 12 O'clock view 500. Similar to the above, the intraoral scan 400 can be calibrated with the 12 O'clock view 500 of the patient 200, while the 3D facial image can be calibrated over the intraoral scan and the 12 O'clock view 500 of the patient 200.

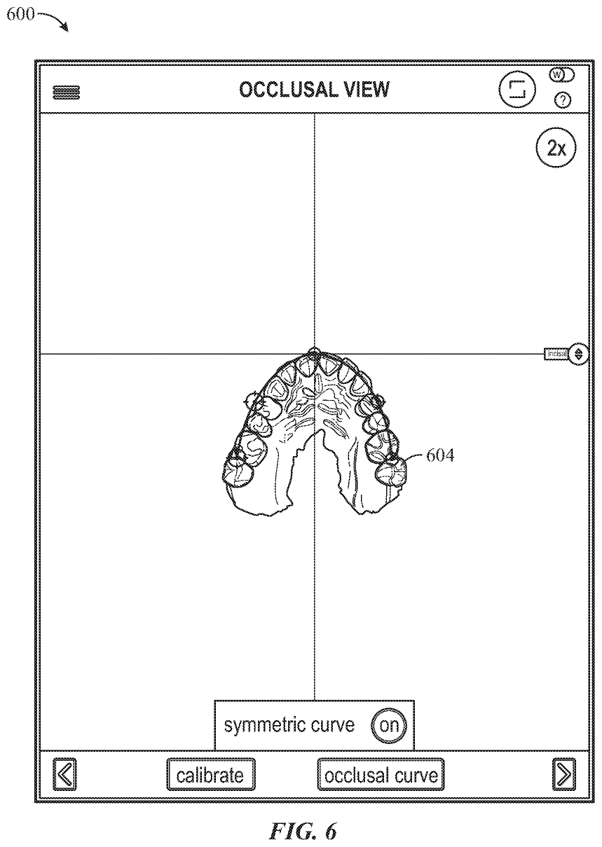

FIG. 6 illustrates an occlusal view 600 incorporating an STL file captured from an intraoral scanner 400. The 3D intraoral scan 604 can be resized according to the frontal facial image 304 by setting the occlusal curve which forms the visual reference for the new dentition of the patient 200.

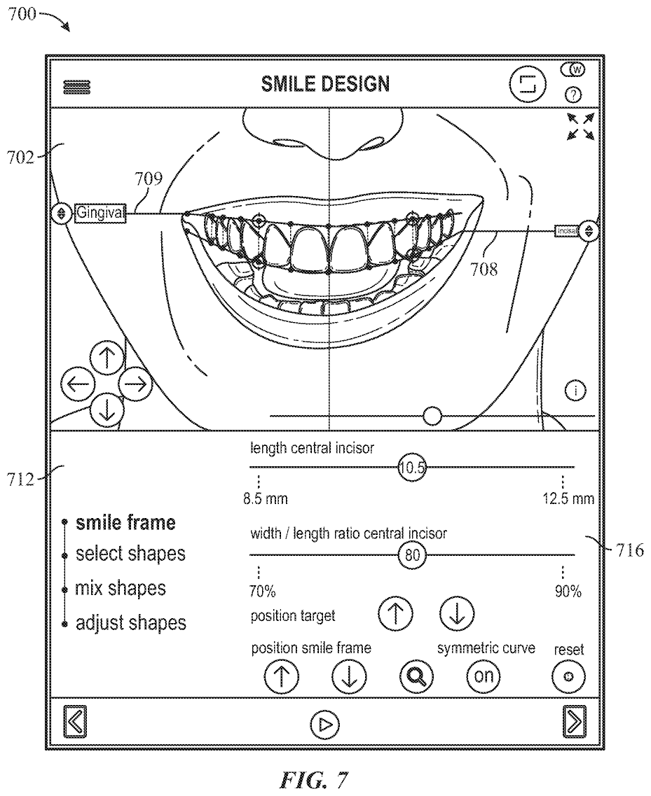

FIG. 7 shows a design interface 700 wherein the user can set proportions for the desired treatment of the patient 200. The patient's dentition is shown within the dentition frame 702. The design interface captures and calculates the proportions of the facial shapes automatically. Shapes can include the gingival line 704 and the incisal line 708. A design control interface 712 permits the user to select parameters to amend including selections for smile frame, select shapes, mix shapes, and adjust shapes. Within the dentition frame control interface 716, the user can adjust the length of the central incisor, adjust the width/length ratio of the central incisor, position the target, position the smile frame, turn the symmetric curve ON/OFF, and reset to the original imagery.

The dentition frame control interface 716 can further include controls which include, but are not limited to position target adjustment, position smile frame adjustment, symmetric curve ON/OFF, and reset controls.

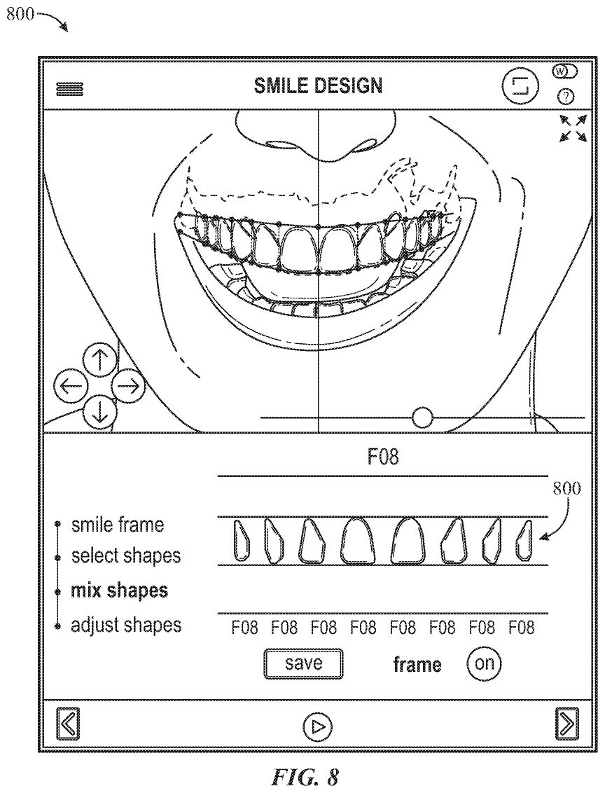

FIG. 8 illustrates the design interface 700 and details the mix shapes interface 800 wherein the user selects shapes according to the patient preferences 40. The dentition frame 702 calculates the position and size of the selected shapes so that the user can compare differences between a variety of templates. In one embodiment, the user can mix shapes between a variety of templates. The dentition frame can automatically display shapes from calculations gained from the dentition frame 702. The calculations provide the best shape combination from all available templates.

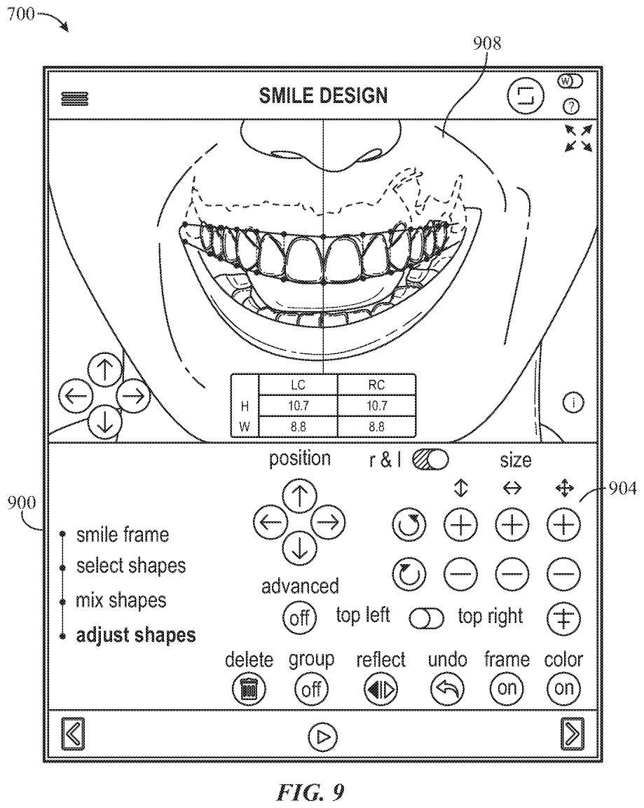

FIG. 9 illustrates the 3D design interface 700 and shows explicitly the adjust shapes interface 900 wherein the user can finish the smile simulation using the plurality of controls 904. The smile simulation 908 can be performed with the visual reference of the face and the intraoral scan provided.

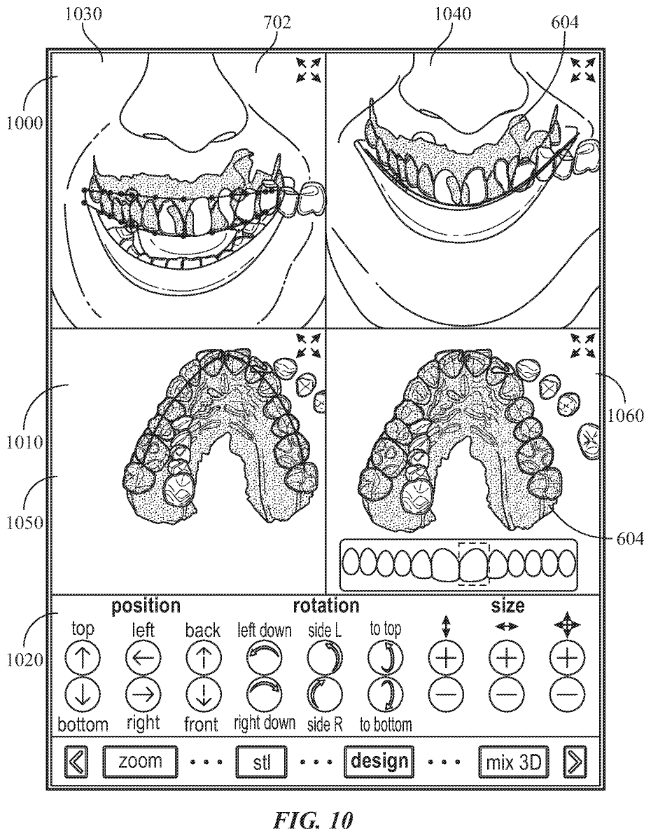

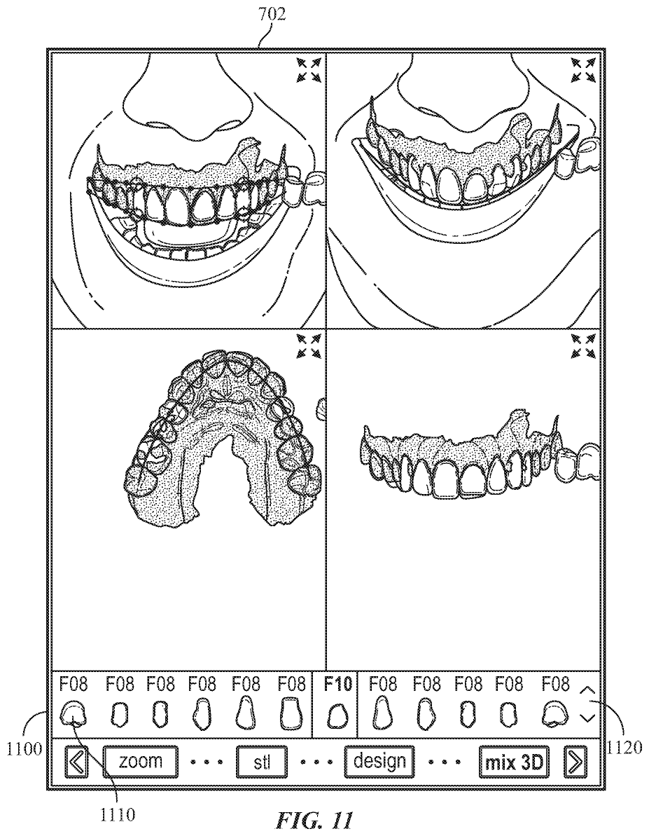

FIG. 10 and FIG. 11 illustrate 3D controls for further calibration of the intraoral scan 400 to suitably fit the 3D image. Controls can finish the design, including adding or removing oral tissue such as gums, tooth fragments, etc., such that edges of the tissues and dentition are smooth. Corners of the tissues can be rounded if needed, or otherwise edited to provide the final 3D facial smile image as it will appear on the patient 200. Features can include the option to reshape, delete, sculpt, or edit the tissues of presented on the 3D dentition frame 702.

Controls 904 can include but are not limited to a position adjustment, size adjustment, delete functions, group controls, reflect controls, undo controls, frame controls, and color controls.

Now referring to FIG. 10, a 3D overlay 1000 of the 3D intraoral scan 604 is shown wherein the user can dynamically alter each component with a plurality of overlay controls 1020. A 3D dynamic scan 1010 is presented with the dentition frame 702 permitting the user to position, rotate, and adjust the size of each shape. The 3D dentition frame 702 calculates the size of the 3D image based on the size of the 2D shapes and the smile simulation 908. This provides an efficient procedure for the design of the aesthetic appliance. In a preferred embodiment, the graphical user interface 20 on the computing device 10 (or personal electronic device) presents four distinct views to the user (a first view 1030, a second view 1040, a third view 1050, and a fourth view 1060). The system 100 designs the smile and the aesthetic appliance in all four views at the same time to ensure consistency and accuracy between each view in 3D space.

The overlay controls 1020 can include but are not limited to position controls, rotation controls, and size controls.

FIG. 11 shows a template 1100 having a plurality of shapes 1110. Each shape 1110 represents a tooth with various configurations stored within the memory 35. The user can browse through templates 1100 using the selector 1120. Each shape 1110 that is selected by the user is then transmitted to the dentition frame 702. Shapes 1110 refer to the aesthetic appearance of the selected tooth within the template.

In one example, the patient information 40 indicates a preference for the central incisor to be square. The user then selects a central incisor square form template 1100 and preferred shape 1110. The generation device 112 can then position and resize the 3D template automatically to show the patient 200 the available shapes 1110 and can figurations that may be selected.

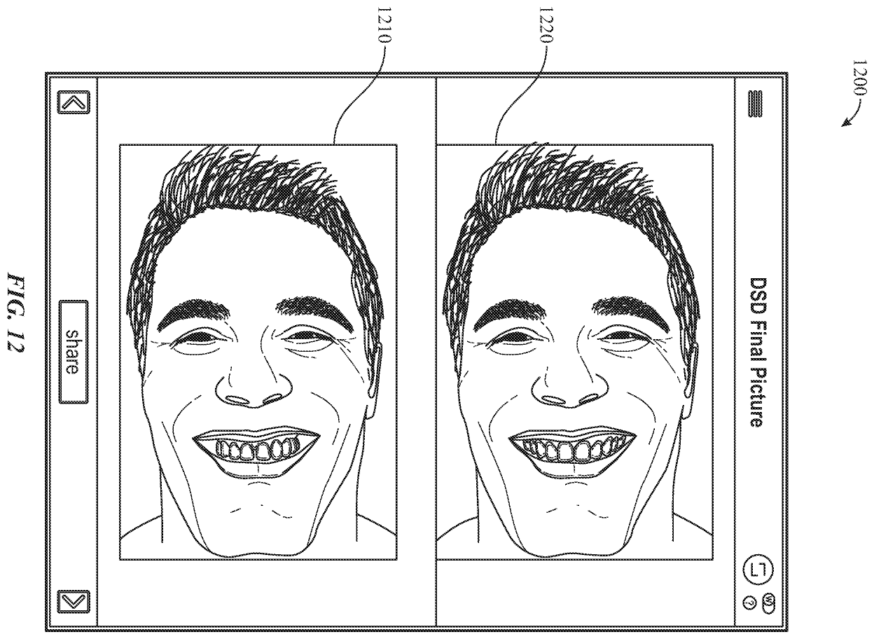

In reference to FIG. 12, the graphical user interface 20 shows a final rendering 1200 having an untreated image 1210 and treated image 1220 of the patient 200. The treated image 1220 is provided once all adjustments (FIGS. 3-11) have been completed and are accepted by the patient 200. The final design is generated and transmitted to the aesthetic appliance production site 110 having at least one aesthetic appliance production device 124.

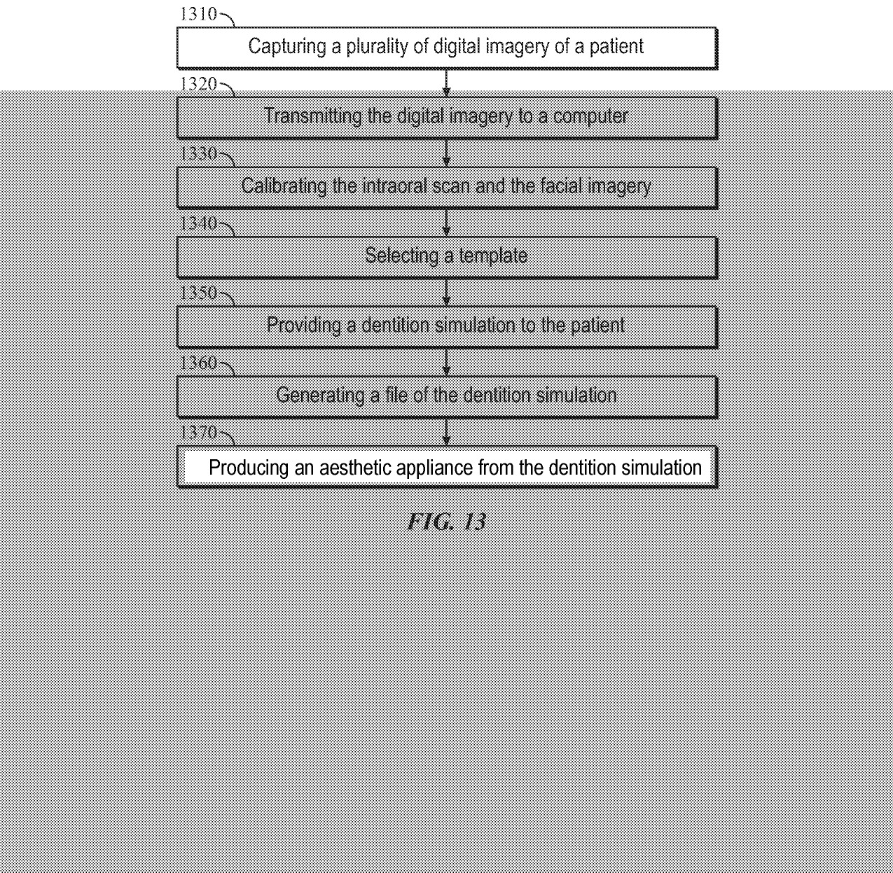

FIG. 13 provides a flowchart of a method for generating a dentition design using the system 100. In the preferred embodiment, and in step 1310, the practitioner captures a plurality of digital imagery 50 of the patient 200. This can be done using any combination of imaging devices 45 as described above. In the preferred embodiment, this consists of the front facial view 204, the 12 O'clock view 208, and the intraoral scan 212 of the patient 200. In step 1320, the digital imagery 50 is transmitted to the computing device 10 which can include any computing device or personal electronic device known in the arts. The digital imagery 50, including the intraoral scan and the facial imagery, is calibrated in step 1330. The user is presented with a plurality of templates 1100 each having a plurality of shapes 1110 to select from in step 1340. Each shape 1110 can correspond to tooth shapes and sizes stored in a database. In step 1350, a dentition simulation is provided to illustrate a rendering of the patient 200 having the selected shapes 1110. A file is then generated in step 1360 which contains the dentition simulation. This file will be sent to the aesthetic appliance production device 124 which, in step 1370, produces the aesthetic appliance from the dentition simulation.

In one embodiment, the user hides the smile of the patient beneath the smile simulation 908 to facilitate a clear display thereof. This allows the smile simulation 908 to be clearly shown to the patient 200 before the receiving the dental appliance is provided.

As described above, the intraoral scan 400 is to be calibrated on the image of the patient 200 in addition to the 3D facial image generated by the system 100. In step 1400, the position of the frontal image of the patient 200 is calibrated and the mouth is marked in step 1410. In step 1420, the position of the intraoral scan 400 is calibrated over the image of the patient 200. In step 1430, the 3D image is calibrated over the image of the patient 200 and the intraoral scan 400. Steps 1410, 1420, and 1430 are then repeated for the profile image of the patient 200 (step 1440). In step 1450, the lip is selected in the 3D facial image to position the 3D smile within the mouth of the patient 200. The user can then reshape, delete, sculpt, and edit the 3D smile and 3D image in step 1460. This can include adding or removing oral tissues, sculpting the oral tissues, and otherwise editing the 3D image is described above.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for generating an aesthetic appliance, the system comprising:
a. a clinical site having a plurality of imaging devices to capture digital imagery of a patient;
b. a computing device to receive the digital imagery; and
c. a network communicatively coupling the computing device and an aesthetic appliance production site including an appliance generation device and an aesthetic appliance production device configured to produce an aesthetic appliance.

2. The system of claim 1, wherein the computing device is a personal electronic device.

3. The system of claim 1, wherein the digital imagery includes at least the following: a frontal facial image, a 12 O'clock image, and an occlusal view image.

4. The system of claim 3, wherein the occlusal view image is an intraoral scan of the patient.

5. The system of claim 1, wherein the aesthetic appliance production device is a 3D printer or a milling machine.

6. The system of claim 5, wherein the aesthetic appliance production device is provided at the clinical site, wherein the aesthetic appliance production device is in operable communication with the computing device to receive the dentition simulation therefrom.

7. The system of claim 1, further comprising a method having the steps of:
a. capturing via the plurality of imaging devices, a plurality of digital imagery of the patient;
b. transmitting the digital imagery to the computing device via a processor coupled thereto;
c. calibrating the digital imagery;
d. selecting a template;
e. providing a dentition simulation to the patient;
f. generating a file of the dentition simulation; and
g. producing the aesthetic appliance from the dentition simulation.

8. A system for generating an aesthetic appliance, the system comprising:
a. a clinical site having a plurality of imaging devices to capture digital imagery of a patient;
b. a computing device to receive the digital imagery; and
c. a network communicatively coupling the computing device and an aesthetic appliance production site including an appliance generation device and an aesthetic appliance production device configured to produce an aesthetic appliance, wherein the aesthetic appliance is produced via the steps of:
i. capturing via the plurality of imaging devices, a plurality of digital imagery of the patient;
ii. transmitting the digital imagery to the computing device via a processor coupled thereto;
iii. calibrating the digital imagery;
iv. selecting a template;
v. providing a dentition simulation to the patient;
vi. generating a file of the dentition simulation; and
vii. producing the aesthetic appliance from the dentition simulation.

9. The system of claim 8, wherein the computing device is a personal electronic device.

10. The system of claim 8, wherein the digital imagery includes at least the following: a frontal facial image, a 12 O'clock image, and an occlusal view image.

11. The system of claim 10, wherein the occlusal view image is an intraoral scan of the patient.

12. The system of claim 11, wherein the step of calibrating the digital imagery further comprises the step of calibrating the intraoral scan to the frontal facial image and the 12 O'clock image.

13. The system of claim 8, wherein the aesthetic appliance production device is a 3D printer or milling machine.

14. The system of claim 13, wherein the dentition simulation is a 3D 360° view of the patient.

15. A method for generating an aesthetic appliance, the method comprising the steps of:
i. capturing via a plurality of imaging devices at a clinical site, a plurality of digital imagery of a patient;
ii. transmitting the digital imagery to the computing device via a processor coupled thereto;
iii. calibrating the digital imagery;
iv. selecting a template;
v. providing a dentition simulation to the patient;
vi. generating a file of the dentition simulation; and
vii. producing the aesthetic appliance from the dentition simulation.

16. The method of claim 15 further comprising:
a. a network communicatively coupling the computing device and an aesthetic appliance production site which including an aesthetic appliance generation device and an aesthetic appliance production device configured to produce an aesthetic appliance.

17. The method of claim 16, wherein the aesthetic appliance is produced via a 3D printer or a milling machine.

18. The method of claim 15, wherein the digital imagery includes at least the following:
a frontal facial image, a 12 O'clock image, and an occlusal view image.

19. The method of claim 18, wherein the occlusal view image is an intraoral scan of the patient.

20. The method of claim 15, wherein the step of calibrating the digital imagery further comprises the step of calibrating the intraoral scan to the frontal facial image and the 12 O'clock image.
